(19) United States
(12) Patent Application Publication
(10) Pub. No.: US 2006/0291440 A1
(43) Pub. Date: Dec. 28, 2006

(54) Communication relay apparatus and communication receiver

(75) Inventors: Christoph Hausl, Munich (DE); Frank Schreckenbach, Munich (DE); Ioannis Oikonomidis, Munich (DE); Gerhard Bauch, Munich (DE)

Correspondence Address: EDWARDS & ANGELL, LLP, P.O. BOX 55874, BOSTON, MA, 02205, US

(73) Assignee: NTT DoCoMo. Inc., Tokyo (JP)

(21) Appl. No.: 11/445,511

(22) Filed: Jun. 1, 2006

(30) Foreign Application Priority Data
Jun. 1, 2005 (EP) 05011865.2

(51) Int. Cl. H04Q 7/28; H04J 3/04

(52) U.S. Cl. 370/340; 370/535

(57) ABSTRACT

A communication relay apparatus for providing a network-encoded information unit sequence comprises a first channel decoder which is configured to supervise a first wireless channel, to receive a first channel-encoded sequence of information units from a first data source via the first wireless channel and to decode the first channel-encoded sequence of information units to obtain a first decoded sequence of information units. Furthermore, the communication relay apparatus comprises a second channel decoder which is configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other. Finally, the communication relay apparatus comprises a network-encoder which is configured to encode information of the first and second decoded sequences of information units into the network-encoded information unit sequence and wherein the network-encoder is further configured to wirelessly transmit the network-encoded information unit sequence to a data sink.

### BACKGROUND OF THE INVENTION

### Cross-Reference to Related Application

This application claims priority from European Patent Application No. 05011865.2, which was filed on Jun. 1, 2005, and is incorporated herein by reference in its entirety.

### Field of the Invention

The present invention relates to digital communication systems, and more particularly to digital communication networks.

### Description of Related Art

A digital communication network consists of one or several sources, intermediate nodes (relays) and one or several sinks. Information has to be transmitted from the source(s) to the sink(s) over the network whereas the nodes are often connected by band-limited channels with time-varying disturbance. The technical aim is to provide a high quality communication with low bit error rate whereas the total transmission power is restricted.

A known solution to transmit data from a source to a sink over a network is to route the information through the network. To protect the information against errors, the source channel-encodes the information, the relay tries to reconstruct the information with a channel decoder, channel-encodes the information again and sends it to the next relay or to the sink. The sink tries to reconstruct the information by considering all the information which was sent to the sink. In B Zhao and M. Valenti, “Distributed Turbo Coded Diversity for the Rayleigh Channel”, Electronic Letters, 39: 786-787, 2003, it was shown how a distributed turbo code can be used in a system with one source, one relay and one sink. Turbo codes are iterative channel codes which provide a much better performance than non-iterative channel coding schemes.

Moreover, in B. Zhao and M. Valenti, “Practical Relay Networks: A Generalization of Hybrid-ARQ”, IEEE Journal on Selected Areas in Communications, 23(1):7-18, January. 2005, a generalization of the hybrid-automatic repeat request (ARQ) protocol was presented for relay networks which enables a more practical and more flexible use of relays. According to this protocol the source sends channel coded information to the sink. The relays listen to this transmission as well. If a relay is able to decode the information of the source, then it could send additional redundancy to the sink. In the contention period, it is decided, if one of these relays or the source sends the next block with additional redundancy, where the relays and the source inform each other if they have decoded successfully.

However, the known solutions only provide sub-optimal possibility to transmit data with respect to a used power allocation, bandwidth and bit error rate.

Furthermore, iterative decoding of low-density parity-check (LDPC) codes is a powerful method for approaching capacity or AWGN channels (AWGN=additive Gaussian white noise) as it was shown in T. J. Richardson, M. A. Shokrollahi and R. L. Urbanke, “Design of Capacity-Approaching irregular low density parity-check codes”, IEEE Transactions on Information Theory, 47(2):619-637, February 2001.

Document WO 2005/027396 A1 discloses a method and system for transmitting signals in a wireless relay network. The method and system enable two potentials, which can be offered by wireless relay systems, i.e. diversity gains and attenuation savings, to be exploited simultaneously. The method disclosed in WO 2005/027396 Al is characterized in that a relay mounted between the source and the destination decides, independently from information relating to other components of the network, whether a signal received from the source or from at least one other relay is to be decoded and forwarded. The system is characterized in that the relay comprises a decision unit for signal decoding and forwarding decision.

### SUMMARY OF THE INVENTION

Thus, it is the object of the present invention to provide a possibility for a data transmission having improved characteristics.

In accordance with a first aspect, the present invention provides a communication relay apparatus for providing a network-channel-encoded information unit sequence, the communication relay apparatus having a first channel decoder being configured to supervise a first wireless. channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink.

In accordance with a second aspect, the present invention provides a communication relay system having a first communication relay apparatus for providing a network-channel-encoded information unit sequence, the communication relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, wherein the first channel decoder of the first communication relay apparatus is configured to receive a first channel-encoded sequence of information units from a first data source, wherein the second channel decoder of the first communication relay apparatus is configured to receive a second channel-encoded sequence of information units from a second data source and-wherein- the network encoder of the first communication relay apparatus is configured to provide a first network-channel-encoded information unit sequence and to transmit the first network-encoded information unit sequence to a data sink; and a second communication relay apparatus for providing a network-channel-encoded information unit sequence, the communication relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, wherein the first channel decoder of the second communication relay apparatus is configured to receive a third channel-encoded sequence of information units from a third data source, wherein the second channel decoder of the second communication relay apparatus is configured to receive the second channel-encoded sequence of information units from the second data source and wherein the network encoder of the second communication relay apparatus is configured to provide a second network-channel-encoded information unit sequence and to transmit the second network-channel-encoded information unit sequence to the data sink.

In accordance with a third aspect, the present invention provides a method for providing a network-channel-encoded information unit sequence with the steps of receiving a first channel-encoded sequence of information units from a first data source via a first wireless channel and to decode the first channel-encoded sequence of information units to obtain a first decoded sequence of information units; receiving a second channel-encoded sequence of information units from a second data source via a second wireless channel and to decode the second channel-encoded sequence of information units to obtain a second decoded sequence of information units, the first and second wireless channels being different from each other; combining and jointly network-channel-encoding information of the first and second decoded sequences of information units into the network-channel-encoded information unit sequence; and wirelessly transmit the network-channel-encoded information unit sequence to a data sink.

In accordance with a fourth aspect, the present invention provides a communication receiver for providing a first and a second channel decoder output sequence, the communication receiver being configured for receiving a network-channel-encoded sequence being output by a communication apparatus for providing a network-channel-encoded information unit sequence, the communication relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, the communication receiver having a network decoder being configured to receive a network-channel-encoded sequence of information units, the network-channel-encoded sequence of information units comprising information of a first and a second data source, wherein the network decoder is configured to decode the network-channel-encoded sequence of information units into network decoder sequences; a first channel decoder being configured to receive a first channel-encoded sequence of information units from a first data source via a first channel and to decode the first channel-encoded sequence of information units using the network decoder sequence to obtain the first channel decoder output sequence; and a second channel decoder being configured to receive a second channel-encoded sequence of information units from a second data source via a second channel, the first and second channels being different from each other, wherein the second channel decoder is further configured to decode the second channel-encoded sequence of information units using the network decoder sequence to obtain the second channel decoder output sequence.

In accordance with a fifth aspect, the present invention provides a communication receiver system having a communication receiver for providing a first and a second channel decoder output sequence, the communication receiver being configured for receiving a network-channel-encoded sequence being output by a communication apparatus for providing a network-channel-encoded information unit sequence, the communication relay apparatus having a first channel decoder being configured to supervise a first wireless channel, to receive a first channel-encoded sequence of informationf units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, the communication receiver having a network decoder being configured to receive a network-channel-encoded sequence of information units, the network-channel-encoded sequence of information units comprising information of a first and a second data source, wherein the network decoder is configured to decode the network-channel-encoded sequence of information units into network decoder sequences; a first channel decoder being configured to receive a first channel-encoded sequence of information units from a first data source via a first channel and to decode the first channel-encoded sequence of information units using the network decoder sequence to obtain the first channel decoder output sequence; and a second channel decoder being configured to receive a second channel-encoded sequence of information units from a second data source via a second channel, the first and second channels being different from each other, wherein the second channel decoder is further configured to decode the second channel-encoded sequence of information units using the network decoder sequence to obtain the second channel decoder output sequence; and a communication relay apparatus for providing a network-channel-encoded information unit sequence, the communication-relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, or a communication relay system having a first communication relay apparatus for providing a network-channel-encoded information unit sequence, the communication relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, wherein the first channel decoder of the first communication relay apparatus is configured to receive a first channel-encoded sequence of information units from a first data source, wherein the second channel decoder of the first communication relay apparatus is configured to receive a second channel-encoded sequence of information units from a second data source and wherein the network encoder of the first communication relay apparatus is configured to provide a first network-channel-encoded information unit sequence and to transmit the first network-encoded information unit sequence to a data sink; and a second communication relay apparatus for providing a network-channel-encoded information unit sequence, the communication relay apparatus having a first channel decoder being configured to supervise a first wireless channel, to receive a first channel-encoded sequence of information units from a first data source via the first wireless channel and to decode the first channel-encoded sequence of information units to obtain a first decoded sequence of information units; a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink, wherein the first channel decoder of the second communication relay apparatus is configured to receive a third channel-encoded sequence of information units from a third data source, wherein the second channel decoder of the second communication relay apparatus is configured to receive the second channel-encoded sequence of information units from the second data source and wherein the network encoder of the second communication relay apparatus is configured to provide a second network-channel-encoded information unit sequence and to transmit the second network-channel-encoded information unit sequence to the data sink.

In accordance with a sixth aspect, the present invention provides a method for providing a first and a second channel decoder output sequence, the method being adapted to receive a network-channel encoded sequence being output according to a method for providing a network-channel-encoded information unit sequence having the steps of receiving a first channel-encoded sequence of information units from a first data source via a first wireless channel and to decode the first channel-encoded sequence of information units to obtain a first decoded sequence of information units; receiving a second channel-encoded sequence of information units from a second data source via a second wireless channel and to decode the second channel-encoded sequence of information units to obtain a second decoded sequence of information units, the first and second wireless channels being different from each other; combining and jointly network-channel-encoding information of the first and second decoded sequences of information units into the network-channel-encoded information unit sequence; and wirelessly transmit the network-channel-encoded information unit sequence to a data sink, the method for providing having the steps of receiving a network-channel-encoded sequence of information units with a network decoder, the network-encoded sequence of information units comprising information of a first and second data source; decoding the network-channel-encoded sequence of information units into a network decoder sequences; receiving a first channel-encoded sequence of information units from a first data source with a first channel decoder via a first channel; decoding the first channel-encoded sequence of information units with the first channel decoder using the network decoder sequence to obtain the first channel decoder output sequence; receiving a second channel-encoded sequence of information units from a second data source with a second channel decoder via a second channel, the first and second channels being different from each other; decoding the second channel-encoded sequence of information units with the second channel decoder using the network decoder sequence to obtain the second channel decoder output sequence. In accordance with a seventh aspect, the present invention provides a computer program having a program code for performing one of the above-mentioned methods, when the computer program runs on a computer.

The present invention is based on the finding that an improvement in transmission characteristics can be realized if a communication relay for the transmission of data from two data sources to one data sink is used, in which the information of the two data sources, for example the information of two mobile stations, are combined in a network-coded signal. In this system design, the relay receives the channel-encoded data of two data sources and channel decodes it. Then the received data of the two data sources is combined into one network-(channel-)encoded data stream in which the data of the two data sources is identified, for example, by a special signature or header. Preferably, by the use of a special code in this network-encoding operation, this network-encoded data stream is furthermore also channel-encoded. After the network-encoding operation, the network-encoded data is transmitted to the data sink in which a network-decoding operation can be carried out such that the (decoded) information of the two data sources can additionally be used to decode the information which is directly received from the two data sources.

The present invention provides the advantage that the new solution allows to transmit data with a lower bit error rate when the same transmission power and the same bandwidth is used. Alternatively, less transmission power or bandwidth is necessary to obtain the same quality of service or a higher data throughput can be achieved with the same bandwidth.

Especially, if a rate-compatible network-channel code and an (extended) generalized hybrid-ARQ protocol is used, a decentralized relay organization is possible. This has the following advantages:
1. Optional use of a relay. This is important because in wireless system a relay will not be always available.
2. No additional requirements at the sources. That means the sources have not to know if a relay is available.
3. The sink (e.g. the base station in a cellular based mobile communication system) has not to organize the relay transmission.

The inventive approach has the advantage that no contention period is necessary. This enables are more efficient protocol.

Thus, the inventive approach allows to organize networks more economically. This applies especially for cellular based mobile communication systems with relay transmission. Especially, with the combination of network coding and iterative decoding, bandwidth can be saved and less transmission power is necessary. This saves costs, especially in wireless applications, where bandwidth is rare and expensive. Moreover, battery life can be saved at the transmitter. This is an important economic advantage in mobile communication systems.

The extension and the adaption of the generalized hybrid-ARQ protocol for systems which use iterative network and channel decoding allows a more practical involvement and in ad-hoc networks. Thus, the involvement of relays is brought closer to possible applications. The use of relays in cellular based mobile communication systems achieves lower costs for the infrastructure, because relays allow an enlargement of the cells. Therefore, less cells and base stations are necessary to cover a certain area.

### BRIEF DESCRIPTION OF THE DRAWINGS

In the following, preferred embodiments of the present invention are explained in more detail with reference to the accompanying drawings, in which:

FIG. 1 shows a schematic diagram of the use of the present invention;

FIG. 2 shows a block diagram of a first embodiment of the present invention;

FIG. 3 shows diagrams of Tanner graphs for decoding according to the embodiment of the present invention as shown in FIG. 2;

FIG. 4 shows an embodiment of the inventive communication receiver;

FIG. 5 shows a table of a special combination of variables for use of the disclosed embodiments of the present invention;

FIG. 6 shows a diagram in which a comparison of the bit error rates of several system designs, including an embodiment of the present invention, is disclosed;

FIG. 7 shows a diagram in which a comparison of the frame error rates of several system designs, including an embodiment of the present invention, is disclosed; and

FIG. 8 shows system designs in which one relay serves for transmission of data from more than two data sources and in which one data source uses more than one relay.

### DESCRIPTION OF THE PREFERRED EMBODIMENTS

Equal or similar elements are denoted with equal or similar reference signs, wherein a repetition of the explanation of these elements is omitted.

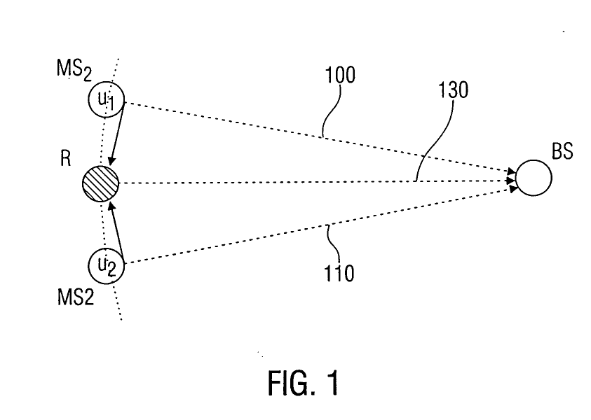

In a network with two sources, one relay and one sink (e.g. uplink in a cellular based mobile communication system as shown in FIG. 1) the two sources (for example users) MS1 and MS2 want to transmit statistically independent data which are segmented in blocks u₁ and u₂ with the block length K to the sink (base station) BS. In order to support the transmission, even in the case of a weak first channel 100 or a weak channel 110, a relay R is used which is provided with data from a first source MS1 and a second source MS2. The relay R can then transmit the information received from the first and second sources MS1 and MS2 via the relay channel 130 to the sink BS.

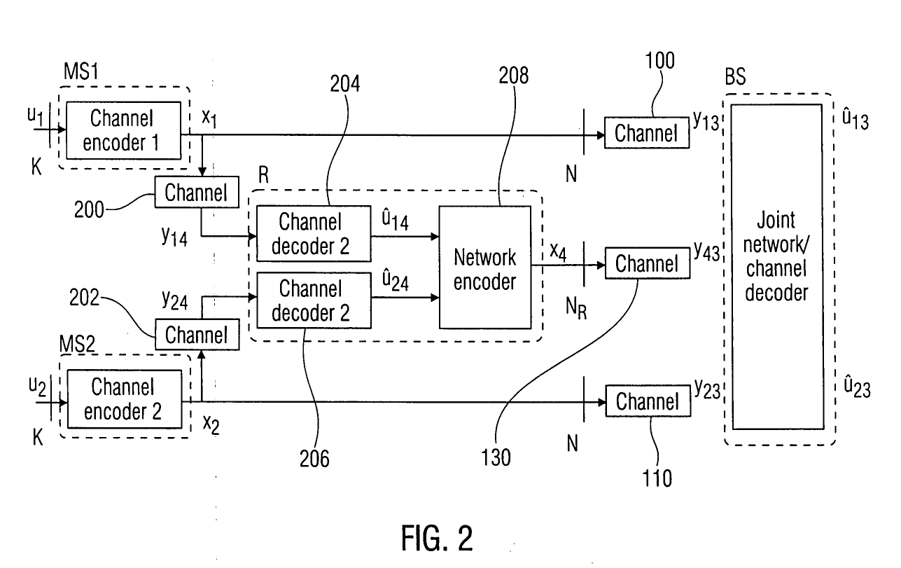

A block diagram of an embodiment of the inventive approach is depicted in FIG. 2. The information units (e.g. bits) u₁ and u₂ are protected against transmission errors with channel encoders which output channel-encoded information unit sequence x₁ (i.e. channel encoder 1 in MS1) and x₂ (i.e. channel encoder 2 in MS2) with the block length N. The relay R, which receives, due to the transmission via the channel 200 and 202, the distributed versions of the channel-encoded information unit sequence x₁ (i.e. y₁₄) and x₂ (i.e. y₂₄) can decode the received sequences and should provide additional error protection by using linear network coding. This means that the relay receives the information y₁₄ from the first source MS1 and decodes it in the first channel decoder 1 204 to obtain the first estimate û₁₄ wherein the relay receives the information y₂₄ from the second source MS2 and decodes it in the second channel decoder 2 206 in order to obtain the second estimate û₂₄.

The both estimates û₁₄ and û₂₄ are linearly jointly combined to the network-encoded information units (e.g. bits) x₄ which have the block length N_{R}. This joint network-encoding operation is carried out in the network encoder 208 as shown in FIG. 2. Herein, the network encoder 208 can use a network code for combining the information of the first and second data sources into one data stream. This combined data stream can be channel encoded by the choice of a special network-channel code (e.g. a LDPC=low-density parity-check code) in order to provide an improved protection when the network-encoded data stream is transmitted via the channel 130 linking the communication relay apparatus R with the data sink (base station BS). Nevertheless, the output data stream x₄ of the communication relay apparatus R is denoted in the present description only as “network-encoded” sequence of information units x₄ as the main feature of this sequence is that it comprises the information of both, the first and second data sources which are derived from the estimates û₁₄ and û₂₄. In the sink BS (base station) a joint network/channel decoder can be configured such, that it provides a first output information sequence û₁₃ and a second output information sequence û₂₃ wherein the first information output sequence is assumed to comprise data send from the first source and wherein the second output information sequence is assumed to comprise data sent from the second source. The exact way for deriving the first and second output information sequences from the information sequences, the sink receives from the first and second sources and the relay is discussed in more detail below.

Further, the channel model used in this example is discussed in more detail. Here, the case of a general AWGN fading channel is considered which can be described by
yᵢ₃=aᵢ·xᵢ+nᵢ,
for iε{1, 2, 4} where the noise is nᵢ is zero mean and Gaussian with variance σ² and the elements of the code blocks xᵢ are either −1 or +1. The channel factor aᵢ, which is constrained by E[aᵢ²]=1, is Rayleigh distributed and represents the fading due to multipath propagation and the motion of the transmitter. The fading factors aᵢ (iε{1, 2, 4}) of the three channels are assumed to be statistically independent and constant over one block. As fading only appears at the channel from the relay R to the base station BS, if the relay is mobile (e.g. another user is the relay), a second model for this channel is also considered. If the relay is stationary (e.g. installed at a traffic light) this channel is assumed to be an additive white Gaussian noise (AWGN) channel without fading (a₄=1).

Further, channel and network coding is referred to in more detail. An LDPC code, as already mentioned in the introductory portion, can be either characterized through the parity check matrix H or the corresponding Tanner graph. In this section, it is shown that the Tanner graph provides a framework to describe the channel code and the network code and allows to decode them jointly.

First, channel coding is dealt with. Linear block codes (e.g. LDPC codes) are used for the channel coding at MS1 and MS2 in this embodiment of the present invention. The two LDPC codes with rate R=K/N are linear block codes specified by sparse parity-check matrices Hᵢ (iε{1, 2}) with N columns and N−K rows. The Tanner graph of an LDPC code consists of N variable nodes on one side and N−K check nodes on the other side, as explained in more detail below. Each variable node represents for example a code bit, each check node for example a parity check equation which corresponds to one row of Hᵢ. The code bits xᵢ=uᵢGᵢ(iε{1, 2}) are generated from the information bits by multiplication with the generator matrix Gᵢ, which has to fulfill the condition GᵢHᵢ^{T}=0.

Further, network coding is dealt with in more detail. The network encoder linearly combines the decoded information bits û₁₄=u₁ and û₂₄=u₂, which are assumed to be recovered correctly, to calculate the network code bits
x₄=u₁G₄₁+u₂G₄₂=[u₁ u₂]G₄.

Herein, G denotes the generator matrix of the network encoder 208 at the relay R. The network code, which has the rate R_{R}=(2·K)/N_{R}, provides N_{R} additional parity-check equations which can support the decoding at the sink BS (base station). In contrast to the channel codes the network code combines the information bits of MS1 and MS2. Therefore, the encoding operations at MS1, MS2 and the relay can be describe jointly:

$$x = [ \begin{matrix}{x}_{1} & {x}_{2} & {x}_{3}\end{matrix} ] = [ \begin{matrix}{u}_{1} & {u}_{2}\end{matrix} ] [ \begin{matrix}{G}_{1} & 0 & {G}_{41} \\ 0 & {G}_{2} & {G}_{42}\end{matrix} ] = uG$$

Although the different coding operations are processed spatially distributed, they will be treated them as one network-channel code with the system rate

$${R}_{S} = \frac{2 \cdot K}{2 \cdot N + {N}_{R}} = \frac{1}{\frac{1}{R} + \frac{1}{{R}_{R}}}$$

The parity-check matrix H of the network-channel code has to fulfill GH^{T}=0 and contains 2·(N−K)+N_{R} rows and 2·N+N_{R} columns. The decoder at the sink BS (base station) can process the message-passing algorithm on the Tanner graph which corresponds to the parity-check matrix H of the network-channel code and thus, exploit the diversity provided by the network coding scheme.

Further, the network-channel code construction is focussed in more detail. Here, it has to be considered how to construct the network-channel code as an LDPC code for example, whereas this will be done for the complete network-channel code in one step, even if the encoders are spatially distributed. The rate of the network-channel code is given by Rₛ=1−dᵥ/d_{c}, where dᵥ is the average degree of the variable nodes and d_{c} is the average degree of the check nodes. Due to the distributed network-channel encoding, parity check equations belonging to a channel code are only allowed to contain code bits of the same channel code, whereas there are no restrictions for the parity-check equations of the network code. Keeping these constraints, we can use an arbitrary linear block code as network-channel code.

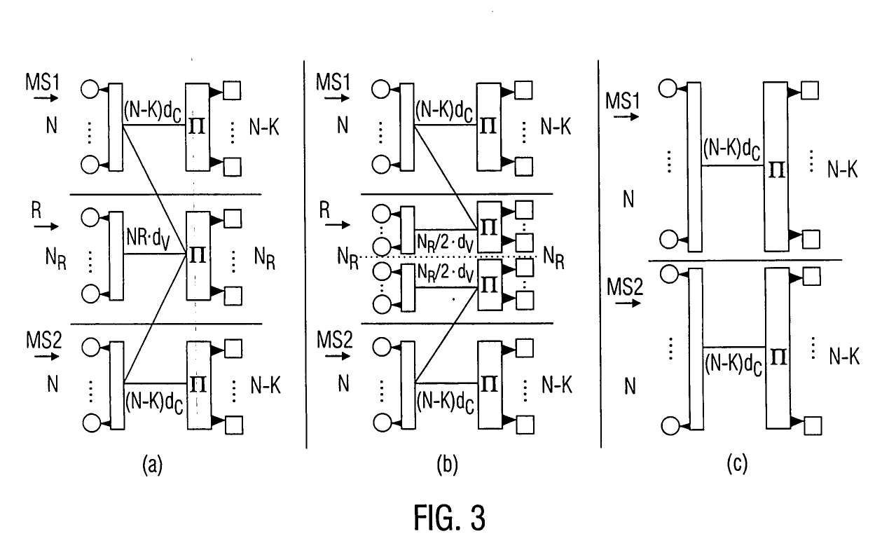

The structure of the Tanner graph corresponding to the network-channel code is depicted in FIG. 3(a). The circles depict the variable nodes and the squares the check nodes. The graph consists of three parts for the two channel codes (upper and lower part) and the network code (middle part). Each part gets the information which initialises the message-passing algorithm from a different channel, whose fading factors are statistically independent. As the network code combines information of the first source MS1 and the second source MS2, its check nodes connect variable nodes of all three code parts and thus, the received information of all channels can be used to decode the information bits of one source (user). This allows to exploit the diversity provided by the three independent fading channels. For example, if the transmission from the first source MS1 to the sink BS (base station) has very strong fading (a₁=0) it could be possible to reconstruct the information bits of the first source MS1 only from the received information from the second source MS2 and the information received from the relay.

Moreover, network coding is combined with channel coding. As the performance of LDPC codes depends strongly on the block length, the joint decoding of the network and the channel code has the advantage that the Tanner graph which is used for decoding has a larger block length, as the information of the two sources (users) is jointly decoded. This positive effect could be used for AWGN channels as well and would be even more significant, if network coding would be applied to the information of more than two sources (users).

As the network code connects and combines the two channel codes the diversity provided by network coding can be exploited in FIG. 3(a). In FIG. 3(b) a structure of the Tanner graph of a first reference system with relay but without network coding is disclosed. Herein, the information originating from the first and second sources MS1 and MS2 are not combined in a joint network-encoded information unit sequence as realized in the present invention. Therefore, FIG. 3(b) only shows two separated paths for the respective information transmitted via the relay channel. In FIG. 3(c) a structure of the Tanner graph of a second reference system without a relay is disclosed. Herein, only the transmission over the first and second channel from the first and second sources to the sink (base station) are shown. To get a fair comparison the sum of the code bits in the system 2N+N_{R} stays constant.

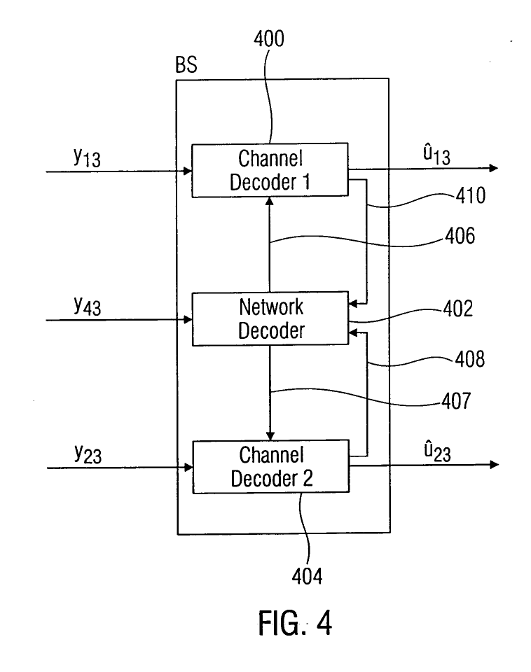

FIG. 4 shows a more detailed block diagram of the sink which is assumed to be a base station BS working as a communication receiver. The base station BS comprises a first channel decoder 300, a network decoder 402 and a second channel decoder 404. The first channel decoder 400 is configured to receive a fist channel-encoded information unit sequence y₁₃ via a channel 100 from a first data source MS1 as can be seen from FIG. 2. The network decoder 402 is configured to receive the network-encoded sequence of information units y₄₃ via a channel 130 from the communication relay apparatus R as shown in FIG. 2. The second channel decoder 404 is configured to receive the second channel-encoded information unit sequence y₂₃ via a second channel 110 from the second data source MS2 as also shown in FIG. 2. Channel decoder 1 and 2 (400 and 404) deliver estimated (soft) information about u₁ and u₂ to the network decoder 402 via the path 410 and the path 408. As the network-encoded sequence of information units comprises information originating from the first and second data sources MS1 and MS2, which is included in the network-encoded sequence of information units, the network decoder 402 is configured to calculate a network decoder sequences 406 and 407 which is provided to the first channel decoder 400 and the second channel decoder 404 where the (soft) information which the network decoder receives via path 410 and 408 has to be used. Furthermore, the network decoder 402 is configured to carry out a network-decoding algorithm in order to separate the information which originates from the first data source from the information which originates from the second data source. Thus, the network decoder provides for both of the channel decoders an additional amount of (soft) information which can be used in the both channel decoder 402 and 404 to reconstruct the received channel-encoded sequence of information units such that the first channel decoder 400 can output the first channel decoder output sequence û₁₃ which, in the optimal case, is exactly the information sequence u₁ which is to be transmitted by the first data source MS1 (as shown in FIG. 2). Same applies also for the decoding of the second channel decoder 402, which is then able, in the best instance, to completely reconstruct the information sequence u₂ being transmitted via the second data source MS2. Then, the second channel decoder output sequence û₂₃ is equal to the information sequence u₂ being transmitted via the second data source MS2. The forwarding of (soft) information from the channel decoder 1 and 2 (400 and 404) to the network decoder 402 via the path 406 and the path 407 and from the network decoder to the channel decoders 1 and 2 via the path 408 and the path 410 has preferably to be repeated several times, whereas the estimation of u₁ and u₂ at the channel decoders improves with each iteration. In this context it can be mentioned, that the network decoder sequence 406 can comprise additional redundancy or original information for reconstructing the information sent of the both data sources in the both channel decoder 402 and 404.

Furthermore, it is also possible that, if the channel 100 as shown in FIG. 2 has a strong fading, the information sent by the first data source MS1 can be completely reconstructed if the network decoder is fed with information transmitted with respect to the second data source MS2. This means that the network decoder 402 can apply a decoding algorithm in which the second channel-encoded sequence of information units y₂₃ received by the data sink or the second channel decoder output sequence û₂₃ are fed via a decoder path 408 to the network decoder 402 in which the received network-encoded sequence of information units and the second channel-encoded sequence of information units y₂₃ received by the data sink or the second channel decoder output sequence û₂₃ are linked in such a way, that the first channel-encoded sequence of information units y₁₃ received by the data sink can be used to reconstruct the data u₁ to be transmitted by the first data source MS1. In an extreme case, it could also be possible, that the first channel decoder output sequence can be completely reconstructed from the network decoder sequence 406, if the first channel-encoded sequence of information units y₁₄ is completely lost in the transmission over the channel 100. Analogously, if the channel 110 as shown in FIG. 2 has a strong fading, the information sent by the second data source MS2 can be completely reconstructed if the network decoder 402 is fed with information transmitted with respect to the first data source MS1. This means that the network decoder 402 can apply a decoding algorithm in which the first channel-encoded sequence of information units y₁₃ received by the data sink BS or the first channel decoder output sequence û₁₃ are fed via a decoder path 410 to the network decoder 402 in which the received network-encoded sequence of information units and the first channel-encoded sequence of information units y₁₃ received by the data sink or the first channel decoder output sequence û₁₃ are linked in such a way, that the second channel-encoded sequence of information units y₂₃ received by the data sink can be used to reconstruct the data u₂ to be transmitted by the second data source MS2. In an extreme case, it could also be possible, that the first channel decoder output sequence can be completely reconstructed from the network decoder sequence 406, if the second channel-encoded sequence of information units y₂₄ is completely lost in the transmission over the channel 110.

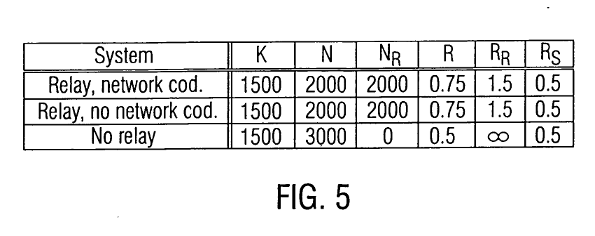

Three systems applying the iterative joint network and channel decoding are compared herein. Simulation results for the system setup with two users, one relay and block Rayleigh fading channels confirm the advantage achieved by the system applying iterative network and channel decoding. We used a regular LDPC code with check nodes with degree d_{c}=6 and variable nodes with degree dᵥ=3 and with the parameters which are denoted in the table in FIG. 5. The parameter selection ensures that the same bandwidth is used by the three systems.

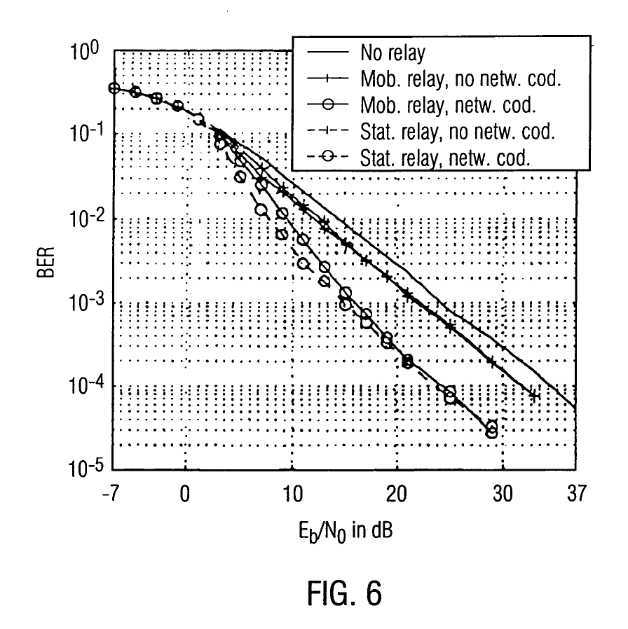

The network-channel code was decoded with the message-passing algorithm with 30 iterations. FIG. 6 discloses simulation results for the bit error rate (BER) of the system applying network coding at a stationary (AWGN) or a mobile (block Rayleigh fading) relay. The system achieves a significant gain compared with the reference systems.

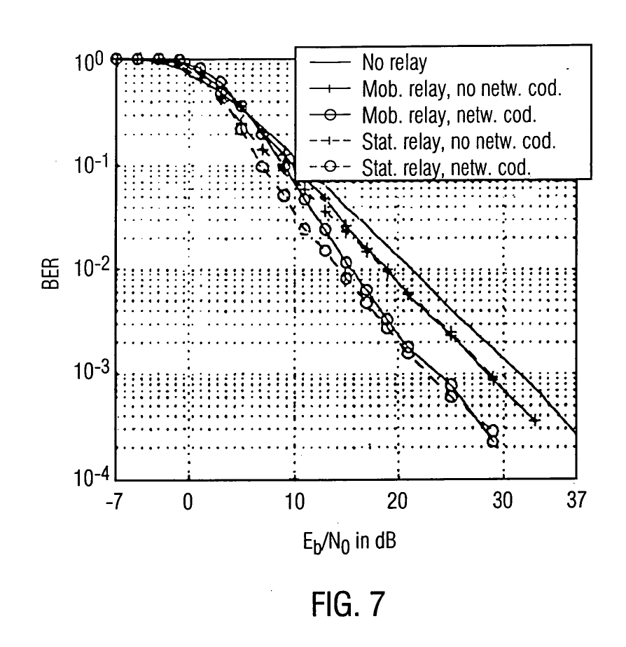

FIG. 7 discloses simulation results for the frame error rate (FER) of the system applying network coding at a stationary (AWGN) or a mobile (block Rayleigh fading) relay. The system achieves a significant gain compared with the reference system.

Thus, FIG. 6 depicts the bit error rate (BER) and FIG. 7 the frame error rate (FER) over the signal to noise ratio (SNR) E_{b}/N₀ in dB. The system applying the iterative joint network and channel decoding achieves a significant gain compared with the reference systems. As the system with the relay but without network coding gains much less, we know that the application of network coding is mainly responsible for the gain.

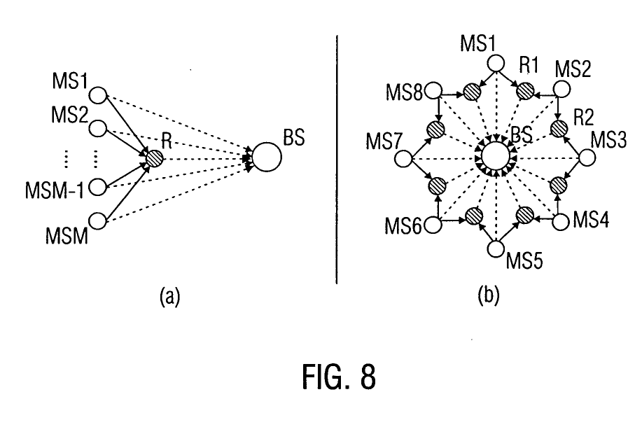

FIG. 8 shows two possible setups with more than two sources (users) where joint network-channel decoding can be applied. The information of all sources (users) is decoded jointly on one Tanner graph.

The application of joint network and channel decoding for more than two sources (users) could be done in several ways. For example, several sources (users) could use one relay (see FIG. 8(a)). Another interesting setup would be, if one relay is only used by two sources (users) but one source (user) uses several relays (see FIG. 8 (b)). The sources can be mobile data sources or one mobile data source and one fixed data source (e.g. base station).

FIG. 8(b) depicts a possible setup with 8 sources (users) and 8 relays. The data from all sources (users) would be decoded on one graph. For both cases the length of the graph could be enlarged by a high factor. This would improve the performance especially in application where short block lengths are used due to delay constraints.

Further, the generalized hybrid-ARQ protocol of B. Zhao and M. Valenti,“Practical Relay Networks: A Generalization of Hybrid-ARQ”, IEEE Journal on Selected Areas in Communications, 23(1):7-18, January 2005 is extend in the following way. Again, the source(s) send channel coded information to the sink. The relays listen to this transmission as well. If a relay is able to decode successfully, it send without any request over an orthogonal channel a packet with additional redundancy to the sink (for example only redundancy is sent to the data sink for an improvement of the reconstruction characteristics in the data sink). This additional redundancy is the output of a network code if the information of several sources was decoded correctly and the output of a channel code if only the information of one source was decoded correctly. The header of this packet contains the information of which source(s) is included in this packet. Therefore, the sink knows which relays have decoded which information successfully and can request more redundancy from one of the sources or the relays until the information of all sources is decoded. This can be decided by certain criteria (e.g. SNR of the connection to the sink and the information of which sources (users) has not been decoded yet). With this extension a contention period is not necessary. However, the receiver can also send an (negative) acknowledge signal to the relay in order to invoke a retransmission of the redundancy to the receiver.

Thus, the combination of routing and an iterative coding scheme is extended to the combination of network coding and an iterative coding scheme. The source(s) us a common relay to send information to one sink. At the source(s) the information is channel encoded and the relay tries to reconstruct the information with a channel decoder. The relay performs network coding, which means that it combines data which were transmitted from different sources. The sink retrieves the channel code bits from the source(s) and the network code bits from the relay.

The channel codes and the network code are described by a single distributed linear block code which is called network-channel code. Here as example a low-density parity-check (LDPC) code is considered. The network-channel code can be decoded at the sink with the iterative message-passing algorithm. Thus, joint network and channel decoding is performed. Furthermore, an exchange of (soft) information between the first and second channel decoders 400, 404 and the network decoder 402 via the paths 406, 407, 408 and 410 can be repeated several times.

The use of a distributed LDPC code for a system with one sink and one relay that does not perform network coding is a special case of the described system. This special case corresponds to the distributed turbo code which was presented in B Zhao and M. Valenti, “Distributed Turbo Coded Diversity for the Rayleigh Channel”, Electronic Letters, 39: 786-787, 2003.

The proposed approach can be extended easily to the use of several sources, several relays and several sinks. Furthermore, an extension of the generalized hybrid-ARQ protocol of B. Zhao and M. Valenti, “Practical Relay Networks: A Generalization of Hybrid-ARQ”, IEEE Journal on Selected Areas in Communications, 23(1):7-18, January 2005 is proposed where the sink decides if one of the sources or one of the relays sends the next packet. Then no contention period is necessary. The (extended) generalized hybrid-ARQ protocol can be adapted and applied for a system which uses iterative network and channel decoding if the network-channel code is rate-compatible.

To summarize, the present invention considers a communication network with one or several sources, intermediate nodes (relays) and one or several sinks. The intermediate communication channels are band-limited channels with time-varying disturbance.

To enable a reliable and efficient transmission, a distributed linear block code is proposed. The sources channel-encode the data and transmit the encoded data to the nodes and the sink. At the nodes, the data from different sources is combined through a linear network code. At the sink, the channel codes and the network codes are considered jointly and are decoded on a single graph. The decoding on a graph is usually done with a message passing algorithm. Low-density parity-check (LDPC) codes are well suited candidates for this distributed code.

In addition, a hybrid-ARQ protocol with a decentralized node organization is proposed. There, the nodes are able to combine the data from available sources through the network code and to send this additional redundancy to the sink without any explicit request.

Moreover, depending on certain implementation requirements of the inventive methods, the inventive methods can be implemented in hardware or in software. The implementation can be performed using a digital storage medium, in particular a disk or a CD having electronically readable control signals stored thereon, which can cooperate with a programmable computer system such that the inventive methods are performed. Generally, the present invention is, therefore, a computer program product with a program code stored on a machine-readable carrier, the program code being configured for performing the inventive methods, when the computer program product runs on a computer. In other words, the inventive methods are, therefore, a computer program having a program code for performing the inventive methods, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. Communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink.

2. Communication relay apparatus according to claim 1, wherein the first channel decoder and the second channel decoder are configured to supervise mobile wireless channels and wherein the data sources are mobile data sources.

3. Communication relay apparatus according to claim 1, wherein the network-encoder is configured to perform a network-channel coding using a linear block code or a convolutional code.

4. Communication relay apparatus according to claim 3, wherein the linear block code is a low-density parity-check code.

5. Communication relay apparatus according to claim 1, wherein the network encoder is configured to provide the network-channel-encoded information unit sequence having a first code rate and wherein the network encoder is configured to provide a further network-channel-encoded information unit sequence having a second code rate, the first code rate being higher than the second code rate, wherein the network-channel-encoded information unit sequence having the second code rate comprises the information being included in the network-channel-encoded information unit sequence having the first code rate.

6. Communication relay apparatus according to claim 1, further comprising:
a third channel decoder being configured to supervise a third wireless channel, to receive a third channel-encoded sequence of information units from a third data source via a third wireless channel and to decode the third channel-encoded sequence of information units to obtain a third decoded sequence of information units, the first, second and third wireless channels being different from each other; and
wherein the network encoder is configured to network-channel-encode information of the first, second and third decoded sequences of information units into the network-channel-encoded information unit sequence.

7. Communication relay apparatus according to claim 1, wherein the first channel decoder is configured to determine whether the first channel-encoded sequence of information units can be decoded correctly and to provide the first decoded sequence of information units comprising redundancy information for correctly reconstructing a signal sent by the first data source or wherein the second channel decoder is configured to determine whether the second channel-encoded sequence of information units can be decoded correctly and to provide the second decoded sequence of information units comprising redundancy information for correctly reconstructing a signal sent by the second data source.

8. Communication relay apparatus according to claim 7, wherein the network encoder is configured to receive an acknowledge signal from the data sink and wherein the network encoder is configured to, in response to the acknowledge signal, transmit further network-channel-encoded information.

9. Communication relay system comprising:
a first communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
wherein the first channel decoder of the first communication relay apparatus is configured to receive a first channel-encoded sequence of information units from a first data source, wherein the second channel decoder of the first communication relay apparatus is configured to receive a second channel-encoded sequence of information units from a second data source and wherein the network encoder of the first communication relay apparatus is configured to provide a first network-channel-encoded information unit sequence and to transmit the first network-encoded information unit sequence to a data sink; and
a second communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
wherein the first channel decoder of the second communication relay apparatus is configured to receive a third channel-encoded sequence of information units from a third data source, wherein the second channel decoder of the second communication relay apparatus is configured to receive the second channel-encoded sequence of information units from the second data source and wherein the network encoder of the second communication relay apparatus is configured to provide a second network-channel-encoded information unit sequence and to transmit the second network-channel-encoded information unit sequence to the data sink.

10. Method for providing a network-channel-encoded information unit sequence comprising the steps of:
receiving a first channel-encoded sequence of information units from a first data source via a first wireless channel and to decode the first channel-encoded sequence of information units to obtain a first decoded sequence of information units;
receiving a second channel-encoded sequence of information units from a second data source via a second wireless channel and to decode the second channel-encoded sequence of information units to obtain a second decoded sequence of information units, the first and second wireless channels being different from each other;
combining and jointly network-channel-encoding information of the first and second decoded sequences of information units into the network-channel-encoded information unit sequence; and
wirelessly transmit the network-channel-encoded information unit sequence to a data sink.

11. Communication receiver for providing a first and a second channel decoder output sequence, the communication receiver being configured for receiving a network-channel-encoded sequence being output by a communication apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
the communication receiver comprising:
a network decoder being configured to receive a network-channel-encoded sequence of information units, the network-channel-encoded sequence of information units comprising information of a first and a second data source, wherein the network decoder is configured to decode the network-channel-encoded sequence of information units into network decoder sequences;
a first channel decoder being configured to receive a first channel-encoded sequence of information units from a first data source via a first channel and to decode the first channel-encoded sequence of information units using the network decoder sequence to obtain the first channel decoder output sequence; and
a second channel decoder being configured to receive a second channel-encoded sequence of information units from a second data source via a second channel, the first and second channels being different from each other, wherein the second channel decoder is further configured to decode the second channel-encoded sequence of information units using the network decoder sequence to obtain the second channel decoder output sequence.

12. Communication receiver according to claim 11, wherein the first channel decoder is configured to provide a first soft decoder information sequence, wherein the second channel decoder is configured to provide a second soft decoder information sequence, and wherein the network decoder is configured to receive the first or second soft decoder information sequences and to decode a further network-channel-encoded sequence of information units in response to the first or second soft decoder information sequences.

13. Communication receiver according to claim 11, wherein the first channel decoder and the second channel decoder are configured to supervise mobile wireless channels and wherein the data sources are mobile data sources.

14. Communication receiver according to claim 11, wherein the network decoder is configured to perform a network-channel decoding using a linear block code or convolutional code.

15. Communication receiver according to claim 14, wherein the linear block code is a low-density parity-check code.

16. Communication receiver according to claim 11, wherein network decoder is configured to receive the network-channel-encoded information unit sequence having a first code rate and wherein the network encoder is configured to provide a further network-channel-encoded information unit sequence having a second code rate, the first and second code rates being different from each other.

17. Communication receiver according to claim 11, wherein the network decoder is configured to network-decode the network-channel-encoded sequence of information units comprising information of a first, second and third data source, wherein the network decoder is configured to decode the network-channel-encoded sequence of information units into network decoder sequences, the communication receiver further comprising:
a third channel decoder being configured to supervise a third channel, to receive a third channel-encoded sequence of information units from a third data source via a third channel and to decode the third channel-encoded sequence of information units using the network decoder sequence to obtain a third channel decoder output sequence, the first, second and third channels being different from each other.

18. Communication receiver according to claim 11, wherein the first channel decoder, the second channel decoder and the network decoder are configured to determine whether the encoded sequences of information units can be decoded correctly and to send a negative acknowledge signal to a communication relay apparatus in the case, the encoded sequences of information units cannot be decoded correctly or wherein the second channel decoder is configured to determine whether the first channel-encoded sequence of information units can be decoded correctly and to send an acknowledge signal to the communication relay apparatus in the case, the second channel-encoded sequence of information units cannot be decoded correctly.

19. Communication receiver according to claim 17, wherein the network encoder is configured to decode, in response to the acknowledge signal sent to the communication relay apparatus, redundancy information from the network-channel-encoded sequence of information units for the first channel decoder for correctly reconstruct the signal sent by the first data source or wherein the network encoder is configured to decode, in response to the acknowledge signal, redundancy information from the network-channel-encoded sequence of information units for the second channel decoder for correctly reconstruct the signal sent by the second data source.

20. Communication receiver system comprising:
a communication receiver for providing a first and a second channel decoder output sequence, the communication receiver being configured for receiving a network-channel-encoded sequence being output by a communication apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
the communication receiver comprising:
a network decoder being configured to receive a network-channel-encoded sequence of information units, the network-channel-encoded sequence of information units comprising information of a first and a second data source, wherein the network decoder is configured to decode the network-channel-encoded sequence of information units into network decoder sequences;
a first channel decoder being configured to receive a first channel-encoded sequence of information units from a first data source via a first channel and to decode the first channel-encoded sequence of information units using the network decoder sequence to obtain the first channel decoder output sequence; and
a second channel decoder being configured to receive a second channel-encoded sequence of information units from a second data source via a second channel, the first and second channels being different from each other, wherein the second channel decoder is further configured to decode the second channel-encoded sequence of information units using the network decoder sequence to obtain the second channel decoder output sequence; and
a communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink or,
a communication relay system comprising:
a first communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
wherein the first channel decoder of the first communication relay apparatus is configured to receive a first channel-encoded sequence of information units from a first data source, wherein the second channel decoder of the first communication relay apparatus is configured to receive a second channel-encoded sequence of information units from a second data source and wherein the network encoder of the first communication relay apparatus is configured to provide a first network-channel-encoded information unit sequence and to transmit the first network-encoded information unit sequence to a data sink; and
a second communication relay apparatus for providing a network-channel-encoded information unit sequence, the communication relay apparatus comprising:
a first channel decoder being configured to supervise a first wireless channel, to receive a first channel-encoded sequence of information units from a first data source via the first wireless channel and to decode the first channel-encoded sequence of information units to obtain a first decoded sequence of information units;
a second channel decoder being configured to supervise a second wireless channel, to receive a second channel-encoded sequence of information units from a second data source via the second wireless channel and to decode the second channel-encoded sequence of information units to obtain a second decoded sequence of information units, the first and second wireless channels being different from each other; and
a network encoder being configured to combine and jointly network-channel-encode information of the first and second decoded sequences of information units into the network-channel-encoded information unit sequence, wherein the network encoder is further configured to wirelessly transmit the network-channel-encoded information unit sequence to a data sink,
wherein the first channel decoder of the second communication relay apparatus is configured to receive a third channel-encoded sequence of information units from a third data source,
wherein the second channel decoder of the second communication relay apparatus is configured to receive the second channel-encoded sequence of information units from the second data source and wherein the network encoder of the second communication relay apparatus is configured to provide a second network-channel-encoded information unit sequence and to transmit the second network-channel-encoded information unit sequence to the data sink.

21. Method for providing a first and a second channel decoder output sequence, the method being adapted to receive a network-channel encoded sequence being output according to a method for providing a network-channel-encoded information unit sequence comprising the steps of:
receiving a first channel-encoded sequence of information units from a first data source via a first wireless channel and to decode the first channel-encoded sequence of information units to obtain a first decoded sequence of information units;
receiving a second channel-encoded sequence of information units from a second data source via a second wireless channel and to decode the second channel-encoded sequence of information units to obtain a second decoded sequence of information units, the first and second wireless channels being different from each other;
combining and jointly network-channel-encoding information of the first and second decoded sequences of information units into the network-channel-encoded information unit sequence; and
wirelessly transmit the network-channel-encoded information unit sequence to a data sink,
the method for providing comprising the steps of:
receiving a network-channel-encoded sequence of information units with a network decoder, the network-encoded sequence of information units comprising information of a first and second data source;
decoding the network-channel-encoded sequence of information units into a network decoder sequences;
receiving a first channel-encoded sequence of information units from a first data source with a first channel decoder via a first channel;
decoding the first channel-encoded sequence of information units with the first channel decoder using the network decoder sequence to obtain the first channel decoder output sequence;
receiving a second channel-encoded sequence of information units from a second data source with a second channel decoder via a second channel, the first and second channels being different from each other;
decoding the second channel-encoded sequence of information units with the second channel decoder using the network decoder sequence to obtain the second channel decoder output sequence.

22. Method according to claim 21, further comprising the step of:
Providing a first soft decoder information sequence by the first channel decoder;
Providing a second soft decoder information sequence by the second channel decoder;
Decoding the network-channel-encoded sequence of information units in the network decoder using the first soft decoder information sequence or the second soft decoder information sequence in order to provide a first network decoder sequence and a second network decoder sequence;
Providing a further first soft decoder information sequence and a further first channel decoder output sequence by the first channel decoder using the first network decoder sequence;
Providing a further second soft decoder information sequence and a further second channel decoder output sequence by the second channel decoder using the second network decoder sequence;
Decoding the encoded sequence of information units in the network decoder using the further first soft decoder information sequence or the further second soft decoder information sequence in order to provide an improved first network decoder sequence and an improved second network decoder sequence;
Providing an additional first soft decoder information sequence and an additional first channel decoder output sequence by the first channel decoder using the additional first network decoder sequence;
Providing an additional second soft decoder information sequence and an additional second channel decoder output sequence by the second channel decoder using the additional second network decoder sequence.

23. Computer program having a program code for performing the method for providing a network-channel-encoded information unit sequence comprising the steps of:
receiving a first channel-encoded sequence of information units from a first data source via a first wireless channel and to decode the first channel-encoded sequence of information units to obtain a first decoded sequence of information units;
receiving a second channel-encoded sequence of information units from a second data source via a second wireless channel and to decode the second channel-encoded sequence of information units to obtain a second decoded sequence of information units, the first and second wireless channels being different from each other;
combining and jointly network-channel-encoding information of the first and second decoded sequences of information units into the network-channel-encoded information unit sequence; and
wirelessly transmit the network-channel-encoded information unit sequence to a data sink,
when the computer program runs on a computer.

24. Computer program having a program code for performing the method for providing a first and a second channel decoder output sequence, the method being adapted to receive a network-channel encoded sequence being output according to a method for providing a network-channel-encoded information unit sequence comprising the steps of:
receiving a first channel-encoded sequence of information units from a first data source via a first wireless channel and to decode the first channel-encoded sequence of information units to obtain a first decoded sequence of information units;
receiving a second channel-encoded sequence of information units from a second data source via a second wireless channel and to decode the second channel-encoded sequence of information units to obtain a second decoded sequence of information units, the first and second wireless channels being different from each other;
combining and jointly network-channel-encoding information of the first and second decoded sequences of information units into the network-channel-encoded information unit sequence; and
wirelessly transmit the network-channel-encoded information unit sequence to a data sink,
the method for providing comprising the steps of:
receiving a network-channel-encoded sequence of information units with a network decoder, the network-encoded sequence of information units comprising information of a first and second data source;
decoding the network-channel-encoded sequence of information units into a network decoder sequences;
receiving a first channel-encoded sequence of information units from a first data source with a first channel decoder via a first channel;
decoding the first channel-encoded sequence of information units with the first channel decoder using the network decoder sequence to obtain the first channel decoder output sequence;
receiving a second channel-encoded sequence of information units from a second data source with a second channel decoder via a second channel, the first and second channels being different from each other;
decoding the second channel-encoded sequence of information units with the second channel decoder using the network decoder sequence to obtain the second channel decoder output sequence,
when the computer program runs on a computer.
